(19) United States
(12) Patent Application Publication
(10) Pub. No.: US 2008/0090508 A1
(43) Pub. Date: Apr. 17, 2008

(54) COIN STORAGE DEVICE AND ASSOCIATED METHOD, TROLLEY AND COIN HANDLING APPARATUS

(76) Inventors: Arne Skoog, Skurup (SE); Olov Hagerfors, Akarp (SE); Hakan Melin, Akarp (SE); Kristian Bengtsson, Bjarred (SE); Borje Olsson, Fagerhall (SE); Mats Soderlund, Myggenas (SE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/863,818

(22) Filed: Sep. 28, 2007

Related U.S. Application Data
(60) Provisional application No. 60/827,914, filed on Oct. 3, 2006.

(30) Foreign Application Priority Data
Oct. 3, 2006 (SE) 0602082-0

(51) Int. Cl. G07D 9/00

(52) U.S. Cl. 453/3

(57) ABSTRACT

It is presented a coin bag support for supporting coin bags storing coins received from a coin deposit device, the coin bag support comprising: a main body section adapted to fit inside a coin bag, preventing a coin bag having been fitted in an operating position around the coin bag support from slipping off the coin bag support, the main body section comprising: an upper end with an upper opening for receiving coins from the coin deposit device; and a lower end with a lower opening, allowing coins previously received from the coin deposit device to fall into a fitted coin bag. A coin bag support is thus provided to be inserted in a coin bag, providing a simple and user error resilient way of arranging support to coin bags for use with a coin deposit device. A corresponding method, trolley and coin handling apparatus are also presented.

### CROSS-REFERENCE TO RELATED APPLICATIONS

This application claims the benefit of U.S. Provisional Patent Application No. 60/827,914 filed on Oct. 3, 2006, and Swedish Patent Application No. 0602082-0, filed on Oct. 3, 2006.

### INCORPORATION BY REFERENCE

The specification and drawings of U.S. provisional patent application No. 60/827,914, filed Oct. 3, 2006, and the specification and drawings of Swedish patent application no. 0602082-0, filed on Oct. 3, 2006, are incorporated herein in their entirety, by this reference.

### FIELD OF THE INVENTION

The present invention relates generally to cash handling, and more particularly to coin storage.

### TECHNICAL FIELD

Cash handling apparatuses are used for depositing cash such as coins, notes (bills), cheques or coupons. A cash handling apparatus is typically a stand-alone apparatus which is used on a self-service basis by an arbitrary, untrained end-user visiting a public site such as a bank office, mall, shopping area, store, etc.

When using a typical cash handling apparatus, the end-user will place his cash in a cash input area, whereby the cash handling apparatus will discriminate between acceptable cash, such as valid coins in a plurality of different denominations in one or more specified currencies, and unacceptable cash, such as counterfeit coins or coins of a foreign currency. A coin acceptance module handles the discrimination of coins and acts to count the acceptable coins, and also to sort them provided that the coin acceptance module has sorting capabilities, whereas the unacceptable cash will be rejected. A value related to the acceptable cash as counted is determined, normally either as the total value of the counted cash, or the total value minus a certain commission fee or plus a certain bonus. The determined value may be a printed on a receipt or voucher which is dispensed to the end-user so as to allow later redemption of the value at a checkout counter, service desk, etc, or the value may be credited to a bank account or credit card belonging to the end-user. The deposited cash is stored inside the cash handling apparatus for later collection by authorized personnel.

One problem with current cash handling apparatuses is the storage of coins. Coins are often stored in coin bags, and the coin bags are typically fastened on a frame to be kept in place when coins are deposited into the bag. One known solution to keep bags in place is to use clips. However, with clips it is important that the bag is attached properly, as the weight of the coins put a lot of force on the clips, even if the coin bag is supported by standing on a shelf. The service personnel performing this task are often under a lot of time pressure and can therefore easily make mistakes when attaching an empty coin bag. There is thus a risk that the coin bags fall down and coins may fall out of the bag, causing extra work for the already time pressured service personnel to retrieve the fallen coins.

Consequently, there is a need for an improved way of handling coin bags in cash handling apparatuses.

### SUMMARY OF THE INVENTION

An object of the invention is thus to provide a way to more securely place coin bags to receive coins from a coin deposit device.

This object is wholly or partially achieved by a coin bag support for supporting coin bags storing coins received from a coin deposit device, the coin bag support comprising: a main body section adapted to fit inside a coin bag, preventing a coin bag having been fitted in an operating position around the coin bag support from slipping off the coin bag support, the main body section comprising: an upper end with an upper opening for receiving coins from the coin deposit device; and a lower end with a lower opening, allowing coins previously received from the coin deposit device to fall into a fitted coin bag. A coin bag support is thus provided to be inserted in a coin bag, providing a simple and user error resilient way of arranging support to coin bags for use with a coin deposit device.

When a coin bag is fitted in the operating position around the coin bag support, a major part of a lateral area of the coin bag may be covered on the inside by the coin bag support.

A difference in circumference between the coin bag and the main body section may be sufficiently small to prevent a coin bag in the operating position from slipping off the coin bag support.

The coin bag support may further comprise a handle arranged over the upper opening. The handle simplifies operation when separating the coin bag support and the coin bag.

The main body section may further comprise at least one supporting member, the supporting member being adapted to attach the coin bag support on a trolley. Supporting members stabilize the coin bag support on a trolley, reducing a risk of coins falling out of the coin bag.

The supporting member may be located on one vertical side of the coin bag support, allowing the coin bag support to pivot on the trolley using the supporting member.

The supporting member located on one vertical side of the coin bag support may allow the coin bag support to pivot on the trolley using the supporting member to a coin bag placement position where the coin bag support is supported by the trolley, for placing the coin bag around the coin bag support.

The coin bag placement position may be an upside-down position.

The supporting member may comprise a U-shaped bracket.

The main body section may have an essentially octagonal cross-sectional shape.

The main body section may have an essentially triangular cross-sectional shape.

The coin bag support may further comprise fastening means for fastening a coin bag to the coin bag support.

The coin bag support may be adapted to be separable from the coin bag by lifting the coin bag support.

A second aspect of the invention is a method for handling coins from a coin deposit device using a coin bag support, the method comprising the steps of: placing a coin bag around the coin bag support; placing the coin bag support such that an upper opening of the coin bag support is located under a coin output of the coin deposit device; receiving the coins from the coin deposit device through an upper opening of the coin bag support; and removing the coin bag support from the coin bag.

The step of removing the coin bag support may involve lifting the coin bag support from the coin bag.

The step of placing the coin bag support under a coin output may involve: placing the coin bag support in a trolley and placing the trolley such that the upper opening of the coin bag support is located under the coin output of the coin deposit device.

The step of removing the coin bag support may involve: removing the trolley from the coin deposit device and removing the coin bag support from the coin bag.

The step of placing a coin bag around the coin bag support may involve pivoting the coin bag support to a coin bag placement position, placing the coin bag around the coin bag support and pivoting the coin bag support back to a coin receiving position.

A third aspect of the invention is a trolley adapted to hold a plurality of coin bag supports according to the first aspect of the invention.

The trolley may further comprise walls defining a space for each coin bag support, the walls contributing to preventing a coin bag in the operating position from slipping off the coin bag support.

A fourth aspect of the invention is a coin handling apparatus comprising a coin deposit device and a trolley according to the third aspect of the invention.

### BRIEF DESCRIPTION OF THE DRAWINGS

A number of exemplifying but non-limiting embodiments of a cash deposit apparatus according the invention will now be described with reference to the appended drawings.

FIG. 1 shows a block diagram of a coin handling apparatus in an embodiment of the present invention.

FIGS. 2a-d are schematic perspective views of coin bag inserts, or coin bag supports, according to embodiments of the present invention.

FIG. 3 is a schematic perspective view of a coin trolley in an embodiment of the present invention.

FIG. 4 is a schematic perspective view of a coin handling apparatus in an embodiment of the present invention.

FIG. 5 is a perspective view of a coin handling apparatus in an embodiment of the present invention.

FIG. 6 is a schematic perspective view showing a coin bag insert, such one of the coin bag inserts shown in FIG. 5, in more detail.

FIG. 7 is a flow chart illustrating a coin handling method according to an embodiment of the present invention.

### DETAILED DISCLOSURE OF THE INVENTION

Generally, elements in different drawings that are the same, or equivalent or corresponding to each other, are represented by the same or like reference numerals, such that “1nn” and “2nn”, or “xnn”, “xnn” and “xnn”, where x=1 or 2 and n=0 . . . 9, represent such same, equivalent or corresponding elements.

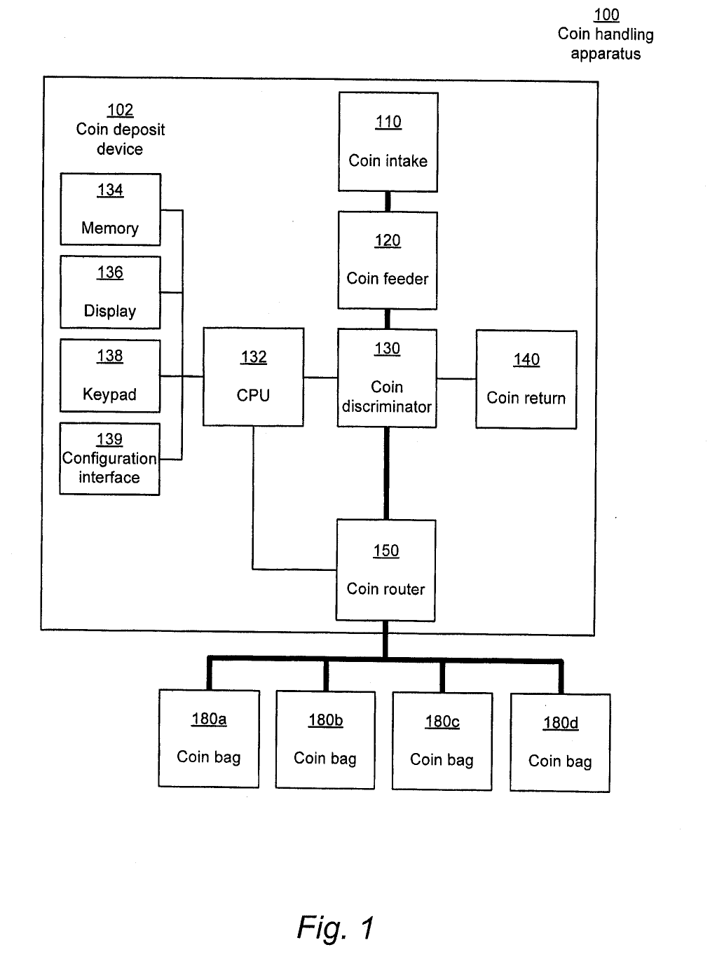

Reference is now made to FIG. 1 which illustrates a modular cash deposit apparatus design.

The general structure of a coin handling apparatus 100 in accordance with the present invention is shown in FIG. 1. A coin deposit device 102 provides its coin output to a coin router 150, which provides the coins to any of coin bags 180a, 180b, 180c or 180d.

In the following, blocks 110, 120, 130, 132, 134, 136, 138, 139, 140 and 150 will collectively be referred to as a coin deposit device 102.

Going into more detail regarding the coin deposit device 102, coins are deposited in a coin intake 110. The coins are transported via a coin feeder 120, for example a hopper-type coin feeding device or a conveyor belt, to a coin discriminator 130. The coin discriminator 130 is operatively connected to a control unit 132 in the form of a microprocessor (CPU) or the like, which in turn is operatively connected to a memory 134, such as a RAM, ROM, EEPROM, flash memory, hard disk, or any combination thereof. At least parts of the memory 134 can be implemented by internal memory in the control unit 132. The control unit 132 is in charge of the overall mode of operation of the apparatus 100, including controlling a display 136 and a key pad 138, which form a user interface. The configuration data relating to the apparatus which the device is intended to update is stored in the memory 134. A configuration interface 139 allows new or modified configuration data to be received by the control unit 132 to be stored in the memory 134. The control unit is normally arranged in the coin deposit device, although it is possible to provide the control by use of an externally connected control unit such as an external control computer.

Discriminator 130 identifies any invalid items, such as foreign coins or tokens, and is configured to direct these items to a coin return 140.

The coin return unit 140 preferably returns non-accepted coins through an external opening in the coin handling apparatus 100. It is the coin discriminator 130 that, in this context, determines if a coin is to be accepted or not by detecting different physical parameters, which are used to determine the type, denomination, currency, identity, authenticity or the like of the coin. Examples of physical parameters are conductivity, permeability, thickness, diameter or weight.

The accepted coins are then provided to the coin router 150. The coin router 150 can be a sorting coin router, routing coins of particular denominations to particular coin bags 180a-d. Alternatively, the coin router 150 can be a coin counting coin router 150, counting the coins and routing the coins of all denominations to one of the coin bags 180a-d until it is determined to be full, after which the coin router 150 routes further coins to another coin bag with the ability to receive more coins. Although four coin bags, 180a, 180b, 180c and 180d are shown, it is to be noted that any number of coin bags is consistent with present invention. The coin bags may be of any type, such as coin bags of plastic or fabric material. The coin bags are held in place by coin bag supports, such as coin bag inserts, as is described in more detail below.

The coin deposit device 102 described above is one example of how a coin deposit device 102 can be constructed. It is provided here by example only and is not to be interpreted as a limitation of the present invention. In other words, the present invention is not limited to one type of coin deposit device, rather it is compatible with any type of suitable coin deposit device.

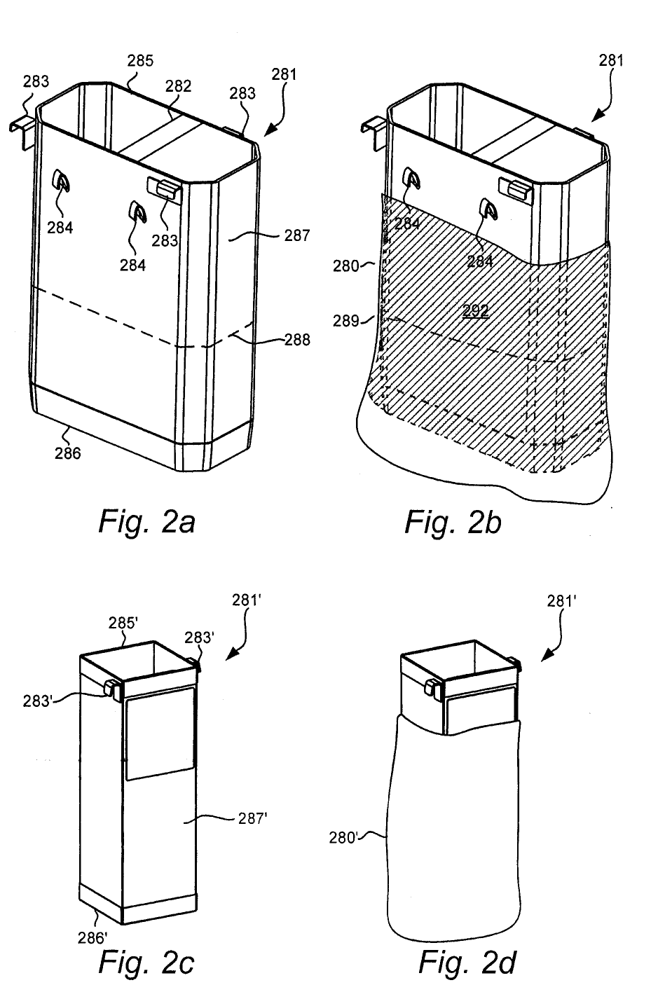

FIGS. 2a-d are schematic perspective views of coin bag inserts, or coin bag supports, according to embodiments of the present invention.

FIG. 2a shows a coin bag insert 281 with an essentially octagonal cross-sectional shape when it is not covered by a coin bag. The coin bag insert 281 is made up of a main body section 287 with an upper opening 285 on its upper end and a lower opening (only partly shown) 286 on its lower end. The main body section 287 can be of any suitable material, e.g. metal or durable plastic material. Supporting members 283 such as hook-like u-brackets 283 allow the coin bag insert 281 to be attached to a trolley or similar, simply by hanging the coin bag insert 281 on corresponding parts on the trolley. The supporting members 283 are placed on the outside of the vertical sides of the coin bag insert 281. An optional handle 282 can be provided on the top of the coin bag insert 281 to facilitate lifting the coin bag insert 281, e.g. when separating the coin bag insert 281 from a coin bag which is described in more detail below. The coin bag insert 281 is thus adapted to be separated from the coin bag simply by lifting the coin bag insert from the coin bag. Due to the weight of coins in the coin bag, the coin bag stays on a supporting surface during the lifting. The lifting is helped by the fact that the coin bag insert and the coin bag can be separated from the main body of the coin handling apparatus 100. Furthermore each coin bad insert 281 is individually separable from a corresponding coin bag and any trolley being present.

Fastening means 284, e.g. coin bag clips, loops for tying the bag, bolts, etc., provide extra security for holding up coin bags if needed.

FIG. 2b shows the coin bag insert 281 of FIG. 2a with a coin bag 280 in an operating position. It is to be noted that the operating position of the coin bag 280 is not a narrowly defined position. Rather, it is any position where the coin bag 280 has been fitted over the coin bag insert 281 such that it will slide off the coin bag insert 281 when coins are received. In particular, the coin bag 280 may initially be unsupported in its bottom area and is only supported by its sides. When coins later fall into the coin bag 280, the coin bag 280 may slip down a small distance, allowing the bottom of the coin bag to be supported by a base below it, such as the base of a coin trolley. The coins will still be contained within the coin bag 280, and as such the coin bag 280 is still considered to be in an operating position.

For regular service personnel, the coin bag 280 is easily fitted in an operating position by sliding it over the coin bag insert 281. The procedure of placing the coin bag around the coin bag insert 281 is described in further detail below. Due to the rigidity of the coin bag 280, and the small distance between the coin bag 280 and the coin bag insert 281, the coin bag 280 is prevented from falling down. The small distance between the coin bag 280 and the coin bag insert 281 can also be expressed as a small difference between a circumference 289 of the coin bag 280 and a circumference 288 of the coin bag insert 281. For a given coin bag insert 281, a threshold difference of circumference, where the coin bag 280 is only just in an operating position, depends on the coin bag 280, in particular to the rigidity of the coin bag 280, and the weight of the coins held by the coin bag 280. Additionally, when the coin bag insert 281 is placed in a trolley, walls exterior to the coin bag 280 contribute to holding the bag up. When a coin bag is fitted on the outside of the coin bag insert 281, as can be seen in FIG. 2b, a major part of a lateral area of the coin bag 280 is covered on the inside by the coin bag insert 281. In other words, there is a common lateral area, being an area where, radially viewed from a centre of the coin bag insert 281, both the coin bag insert 281 and the coin bag 280 are found. This common area is designated by the dashed area 292 (only part visible from perspective view shown), which constitutes a larger part of the lateral area of the coin bag 280. If the rigidity of the coin bag 280 is not enough to prevent it from falling down so that coins in the coin bag 280 may fall out, the coin bag clips 284 can also be used to keep the coin bag 280 up.

FIG. 2c shows a coin bag insert 281′ with an essentially rectangular cross-sectional shape, where this coin bas insert 281′ is smaller than the coin bag insert 281 of FIGS. 2a-b. The coin bag insert 281′ is smaller in order to fit a smaller coin bag. Supporting members 283′, such as hook-like u-brackets 283′ allow the coin bag insert 281′ to be attached to a trolley or similar, simply by hanging the coin bag insert 281′ on corresponding parts on the trolley. Like the coin bag insert described above, there is an upper opening 285′ and a lower opening 286′.

In FIG. 2d, the smaller coin bag insert 281′ is shown with a smaller coin bag 280′, compared to coin bag 280 of FIG. 2b. As described above, the coin bag 280′ is held up by the rigidity of the coin bag 280′ and its restricted freedom of movement due to only having a slightly larger circumference than the coin bag insert 281′.

While only two sizes of coin bag inserts have been shown here, any size of a coin bag insert can be constructed within the scope of the present invention. It is also to be noted that one coin bag insert may be appropriate for use with several sizes of coin bags with a similar circumference.

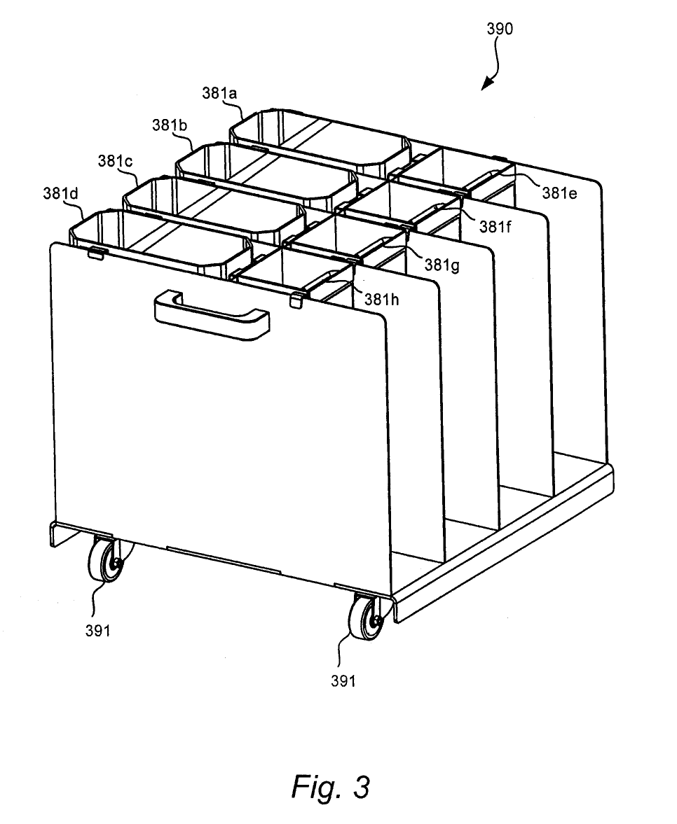

FIG. 3 is a schematic perspective view of a coin trolley 390 in an embodiment of the present invention. This coin trolley 390 has eight slots for supporting eight coin bag inserts with corresponding coin bags. The coin trolley 390 has wheels 391 (only two of four wheels are shown), allowing the trolley 390 to be rolled for easier operation, even when all coin bags in the trolley 390 are full. In the example shown, there are four large coin bag inserts 381a-d, such as coin bag insert 281 of FIG. 2a-b, with corresponding coin bags (not shown) and four small coin bag inserts 381e-h, such as coin bag insert 281′ of FIG. 2c-d, with corresponding coin bags (not shown). It is to be noted that any combination of coin bag inserts suitable for use with a coin deposit device is within scope of the present invention. When the coin trolley 390 is rolled out, any coin bag insert can be pivoted upwards and inwards on the supporting members on the end side wall (closest to the center of the trolley 390) of the coin bag insert 38la-h, pivoting to an upside down position while being supported by one or more of the supporting members 283 (FIG. 2a/2c). The upside down position can be a full 180° compared to a coin receiving position (as seen in FIG. 3), or any angle where the bottom opening faces upwards and it is convenient to slide a coin bag over the coin bag insert.

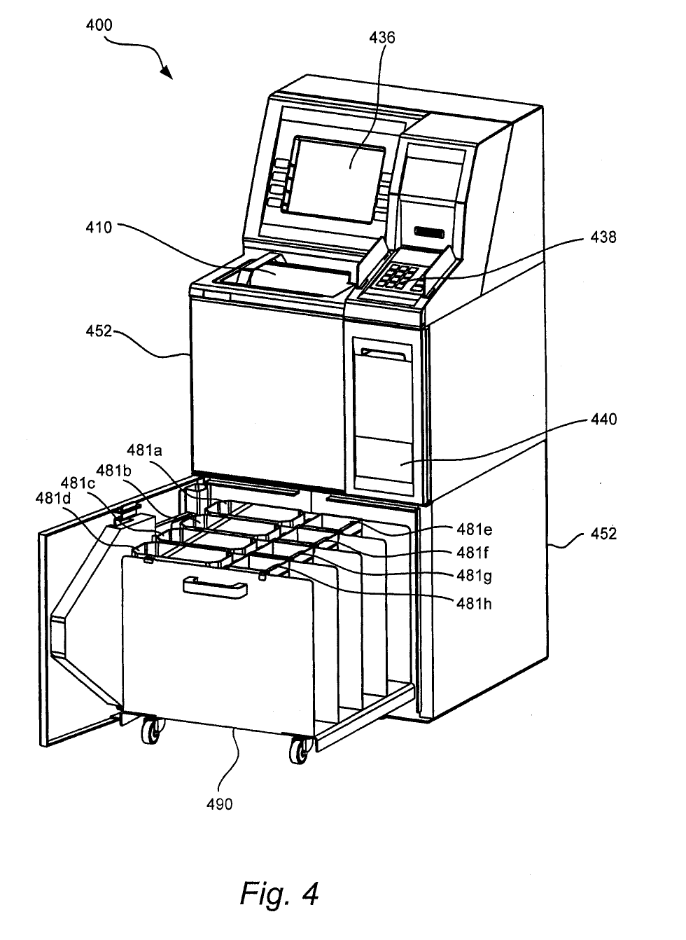

FIG. 4 is a schematic perspective view of a coin handling apparatus 400 in an embodiment of the present invention. The coin bag apparatus comprises a display 436, a keypad 438, a coin intake 410 and a coin return 440, corresponding to the display 136, the keypad 138, the coin intake 110 and the coin return 140 of FIG. 1. A coin router (not shown) is included in a middle cabinet 452. A coin trolley 490, such as coin trolley 390 of FIG. 3, holds eight coin bag inserts 481a-h. The coin trolley 490 is rolled all the way into a lower cabinet 452 before the coin deposit apparatus 400 is in an operational mode. The coin router then routes coins to the coin bag inserts 481a-h and corresponding coin bags. When one or more coin bags are to be emptied, the lower cabinet 452 is opened and the coin trolley 490 is simply rolled out of the cabinet 452. The coin bag inserts 481a-h also alleviate a problem of coins expanding the coin bags past the edge of the coin trolley 490 on the sides, whereby the coin bags get stuck in the cabinet when the trolley is rolled out. The coin bag inserts 481a-h help to contain the coins within the perimeters of the coin trolley 490.

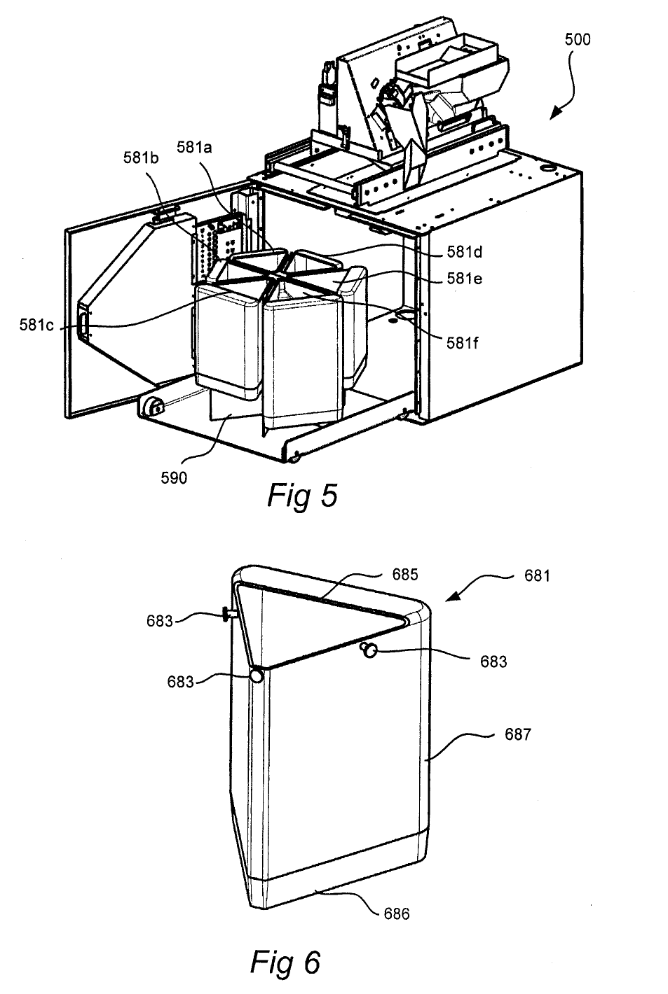

FIG. 5 is a schematic perspective view showing a coin handling apparatus 500 comprising a coin trolley 590 having a slightly different configuration than what is described above. The coin trolley 590 comprises six coin bag inserts 581a-f, typically to accept coins from some sort of a rotational coin router in the coin handling apparatus 500.

FIG. 6 is a schematic perspective view showing a coin bag insert 681, such one of the coin bag inserts 58la-f of FIG. 5, in more detail. The coin bag insert 681 has a main body section 687 with an upper opening 685 and a lower opening (only partly shown) 686. As can be seen, the coin bag insert 681, and its main body section 687, has an essentially triangular cross-sectional shape. As a coin bag is flexible in shape, the coin bag can fit around this coin bag insert 681, as long as the circumference of the coin bag corresponds to the circumference of the coin bag insert 681, where the circumference of the coin bag is slightly larger than the circumference of the coin bag insert 681. This coin bag insert 681 also has supporting members 683, to allow the coin bag insert to be hung in a coin trolley, such as coin trolley 590 of FIG. 5.

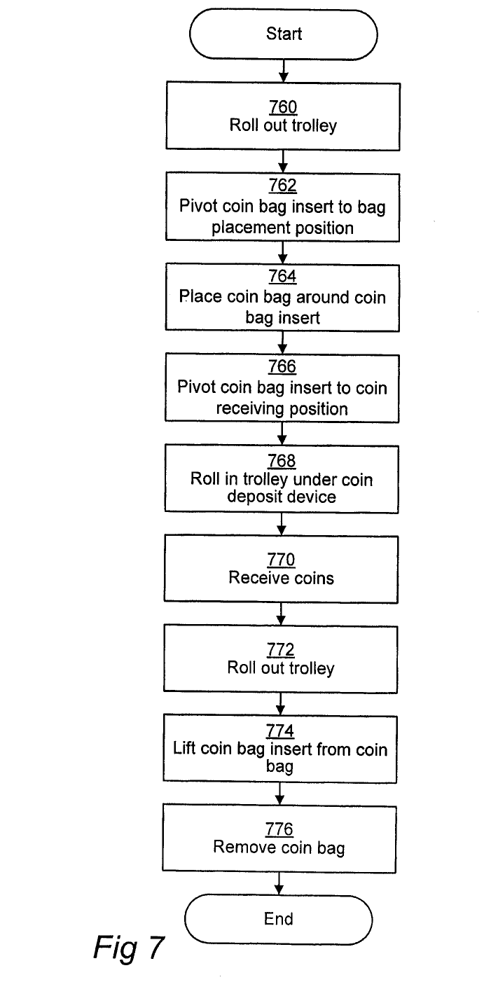

FIG. 7 is a flow chart illustrating a coin handling method according to an embodiment of the present invention.

In a roll out trolley step 760, the coin trolley of a coin deposit apparatus is rolled out. Typically, for security reasons, a door needs to be unlocked first using a key or other unlocking mechanism, whereby the trolley can be rolled out.

Once the trolley is out, in a pivot coin bag insert to bag placement position step 762, a coin bag insert is pivoted to an upside down position. This provides a better position for sliding a coin bag onto the coin bag insert to an operating position over the coin bag insert. The coin bag needs to be in the operating position, to be secure enough to receive coins from the coin deposit device in a later step.

In a place coin bag around coin bag insert step 764, the coin bag is slid over the coin bag insert to an operating position. The coin bag is a coin bag being appropriate for the size of the coin bag insert.

In a pivot coin bag insert to coin receiving position step 766, the coin bag insert, now with a coin bag around it, is pivoted back to a coin receiving position, such as the position of the coin bag inserts 381a-h of FIG. 3, where it can receive coins into the coin bag.

It is to be noted that instead of pivoting the coin bag insert, placing a coin bag around the coin bag insert and pivoting the coin bag insert back, a simpler method can be used. The coin bag insert can be lifted out of the trolley, the coin bag placed around the coin bag insert and the coin bag insert (now with the coin bag around it) placed back in the trolley.

The three steps of: the pivot coin bag insert to bag placement position step 762, the place coin bag around coin bag insert step 764 and the pivot coin bag insert to coin receiving position 766, may be repeated if appropriate to fit coin bags over several coin bag inserts.

In a roll in trolley under coin deposit device step 768, the trolley is rolled back into the coin deposit apparatus to an coin receiving position, where the upper opening of one, some, or all coin bag inserts is located under a coin output of the coin deposit device, allowing coins to fall into the coin bag/bags.

In a receive coins step 770, coins are received in one or more of the coin bags held up by the coin bag inserts in the coin trolley.

When it is decided that one or more coin bags are to be removed from the coin deposit apparatus, the coin trolley is rolled out in a roll out trolley step 772.

In a lift coin bag insert from coin bag step 774, the coin bag insert is removed from the coin bag simply by lifting it up. The coin bag insert is typically reused when a new coin bag is to be fitted in the position in question in the coin trolley.

The coin bag is then easily removed in the remove coin bag step 776.

If appropriate, the two steps of: the lift coin bag insert from coin bag step 774 and the remove coin bag step 776, can be repeated for all coin bags that are to be removed.

Consequently, the novel method described above provides a simple and more user error resilient way to fit and remove coin bags in the coin handling apparatus.

Another aspect of the present invention is a use of a coin bag support in the form of a support having an upper opening and a lower opening, wherein the support has a continuous lateral area with a rigidity being at least as rigid as a coin bag that the coin bag support is intended to support, and the shape of the coin bag support is similar to a lateral shape of the coin bag. The coin bag support in this use may be any embodiment of a coin bag support described elsewhere in this document.

While the present invention was primarily described by way of reference to embodiments of a cash deposit apparatus having a coin-counting or sorting coin discriminator, it is to be noted that it may equally well be applied to other kinds of cash deposit apparatuses, including but not limited to ones that are designed for note counting, note validation, note sorting, cheque validation, voucher validation, marker counting, marker sorting, token counting or token sorting.

While the present invention has been described with example of a coin bag insert with a cross-sectional shape being essentially octagonal, essentially rectangular or essentially triangular, any suitable cross-sectional shape can be used, including, but not limited to a round shape, a hexagonal shape, etc.

Other embodiments than the ones disclosed above are of course possible within the scope of the appended claims, as is readily realized by a person skilled in the art.

What is claimed is:

1. A coin bag support for supporting coin bags storing coins received from a coin deposit device, said coin bag support comprising:
a main body section adapted to fit inside a coin bag, preventing a coin bag having been fitted in an operating position around said coin bag support from slipping off said coin bag support,
said main body section comprising:
an upper end with an upper opening for receiving coins from said coin deposit device; and
a lower end with a lower opening, allowing coins previously received from said coin deposit device to fall into a fitted coin bag.

2. The coin bag support according to claim 1, wherein when a coin bag is fitted in said operating position around said coin bag support, a major part of a lateral area of said coin bag is covered on the inside by said coin bag support.

3. The coin bag support according to claim 1, wherein a difference in circumference between said coin bag and said main body section is sufficiently small to prevent a coin bag in said operating position from slipping off said coin bag support.

4. The coin bag support according to claim 1, wherein said coin bag support further comprises a handle arranged over said upper opening.

5. The coin bag support according to claim 1, wherein said main body section further comprises at least one supporting member, said supporting member being adapted to attach said coin bag support on a trolley.

6. The coin bag support according to claim 5, wherein said supporting member is located on one vertical side of said coin bag support, allowing said coin bag support to pivot on said trolley using said supporting member.

7. The coin bag support according to claim 6, wherein said supporting member located on one vertical side of said coin bag support allows said coin bag support to pivot on said trolley using said supporting member to a coin bag placement position where said coin bag support is supported by said trolley, for placing said coin bag around said coin bag support.

8. The coin bag support according to claim 7, wherein said coin bag placement position is an upside-down position.

9. The coin bag support according to claim 5, wherein said supporting member comprises a U-shaped bracket.

10. The coin bag support according to claim 1, wherein said main body section has an essentially octagonal cross-sectional shape.

11. The coin bag support according to claim 1, wherein said main body section has an essentially triangular cross-sectional shape.

12. The coin bag support according to claim 1, wherein said coin bag support further comprises fastening means for fastening a coin bag to said coin bag support.

13. The coin bag support according to claim 1, wherein said coin bag support is adapted to be separable from said coin bag by lifting said coin bag support.

14. A method for handling coins from a coin deposit device using a coin bag support, said method comprising the steps of:
placing a coin bag around said coin bag support;
placing said coin bag support such that an upper opening of said coin bag support is located under a coin output of said coin deposit device;
receiving said coins from said coin deposit device through an upper opening of said coin bag support; and
removing said coin bag support from said coin bag.

15. The method according to claim 14, wherein said step of removing said coin bag support involves lifting said coin bag support from said coin bag.

16. The method according to claim 14, wherein said step of placing said coin bag support under a coin output involves:
placing said coin bag support in a trolley and placing said trolley such that said upper opening of said coin bag support is located under said coin output of said coin deposit device.

17. The method according to claim 16, wherein said step of removing said coin bag support involves:
removing said trolley from said coin deposit device and removing said coin bag support from said coin bag.

18. The method according to claim 14, wherein said step of placing a coin bag around said coin bag support involves pivoting said coin bag support to a coin bag placement position, placing said coin bag around said coin bag support and pivoting said coin bag support back to a coin receiving position.

19. A trolley adapted to hold a plurality of coin bag supports according to claim 1.

20. The trolley according to claim 19, wherein said trolley further comprises walls defining a space for each coin bag support, said walls contributing to preventing a coin bag in said operating position from slipping off said coin bag support.

21. A coin handling apparatus comprising a coin deposit device and a trolley according to claim 19.
